(19) United States
(12) Patent Application Publication
(10) Pub. No.: US 2006/0209568 A1
(43) Pub. Date: Sep. 21, 2006

(54) Direct type backlight module and related diffusion board

(75) Inventors: Charles Leu, Fremont, CA (US); Tai-Cherng Yu, Tu-Cheng (TW); Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD

(21) Appl. No.: 11/438,026

(22) Filed: May 19, 2006

Related U.S. Application Data
(63) Continuation-in-part of application No. 10/813,408, filed on Mar. 29, 2004.

(30) Foreign Application Priority Data
Mar. 28, 2003 (TW) 92107177

(51) Int. Cl. F21V 8/00

(52) U.S. Cl. 362/629; 362/614

(57) ABSTRACT

The present invention provides a direct type backlight module. The direct type backlight module includes at least one light source (220); and a diffusion board (230) having an incident surface (231) and an emitting surface (232). The at least one light source is arranged behind the incident surface. The diffusion board forms at least one first area (237) corresponding in shape to the contour of the at least one light source and at least one second area (236). Each type of area has a different concentration of fluorescent substance mixed therein. The brightness uniformity of the direct type backlight module can thus be improved.

### BACKGROUND OF THE INVENTION

This application is a Continuation-In-Part of U.S. application Ser. No. 10/813,408, filed on Mar. 29, 2004, which is incorporated by reference thereto.

1. Field of the Invention

The present invention relates to a direct type backlight module and a related diffusion board, particularly to a large sized diffusion board with uniform brightness and a direct type backlight module using the diffusion board.

2. Description of Related Art

A liquid crystal display is capable of displaying a clear and sharp image over a wide area. It is thus used with various devices in which a message or picture needs to be illustrated. However, a liquid crystal itself does not emit light, therefore, it has to be back-lit by a light source to display the messages and/or pictures shown there.

In an ideal liquid crystal display, the backlight most provide light evenly distributed across the entire surface. In addition, the apparatus has to meet the requirements of being small in size, light in weight, bright enough with low power consumption.

U.S. Pat. No. 5,438,484 issued to Kanda et al. disclosed a surface lighting device. A variety of prior art surface lighting devices are disclosed in FIGS. 1 to 5 of the Kanda patent. The light source arranged in the surface lighting device shown is generally referred to as an “edge-type light source”. Kanda describes the disadvantages of the prior art surface lighting device in detail, i.e. the surface area closer to the light sources are brighter than the central area. According to Kanda's explanation in the specification, “However, as described above, the surface lighting device of an edge type has a low luminance in the central portion between the light sources and a high luminance in the vicinity of the light sources as indicated by a broken line C shown in FIG. 9. This is because the light sources 1a and 1b emit diffusion light and make the vicinity of the light sources 1a and 1b bright while the light emitted from the light sources 1a and 1b mostly reach the opposite light source 1b and 1a to be diffused, respectively, thus making the vicinity of the light sources 1a and 1b brighter. As a result, it is inevitable that the effective light range (effective emission surface) of the foregoing lighting device will become narrower because its overall luminance must be adjusted to latch evenly as a backlight with the lowered luminance between the central portion between the light sources 1a and 1b. Thus, a problem is encountered that the light utilization efficiency for the apparatus as a whole is reduced.” See Column 2, lines 31 to 49.

Kanda provides a solution, such as shown in FIGS. 11 to 16, by providing “a light guide configured by a plural light transmitting members joined together, so that the junction surface therebetween crosses the light emitting surface.” As a result and according to Kanda, the luminance emitted from edge-type light sources is evenly distributed across the entire area.

Kanda provides another solution in FIGS. 17 to 23, typically shown in FIG. 23. In this application, the light source is arranged directly behind the liquid crystal display, instead of at the edge of a light guide, as shown in FIG. 1 of the Kanda patent. However, this arrangement indeed provides a brighter central displaying area, but creates a problem of color chromaticity across the liquid crystal display. As explained by Kanda in Column 12, lines 19-49. Kanda then uses a “light source having preferably be more blueish than the standard color” to solve the “yellowish” problem.

Aside from use of the “blueish light source”, it is noted that a “light curtain”, reference numeral 14 of FIG. 22, has also been used to reduce the luminance projected toward the display area immediately in front of the light source. It should be easy to appreciate that the more parts used within the liquid crystal display, the more laborious the effort needed to assemble the display. No doubt, the size and weight of the liquid crystal display will inevitably be increased.

U.S. Pat. No. 5,881,201 issued to Khanarian disclosed improved lightpipes for backlighting liquid crystal display devices. The lightpipes comprise transparent polymers with scattering centers. A preferred composition for such lightpipes comprises a cycloolefin polymer containing scattering centers from suitable elastomers and inorganic fillers. The inventive lightpipes offer superior scattering efficiency as well as spatial uniformity of scattering and uniformity of scattering across a wide wavelength range.

U.S. Pat. No. 5,881,201 issued to Khanarian discloses an improved lightpipe for backlighting applications in liquid crystal display devices. The lightpipes comprise transparent polymers with scattering centers. According to Khanarian, the scattering centers are evenly distributed within the entire lightpipe so as to increase the luminance refractive thereform.

### SUMMARY OF THE INVENTION

A direct type backlight module according to one preferred embodiment includes a diffusion board and a plurality of light sources. The light beams emitted from the light sources have a certain space distribution. The diffusion board is utilized for diffusing the light beams, and the diffusion board has an incident surface configured for receiving the light beams. The diffusion board has fluorescent substance therein, and a distribution of the fluorescent substance corresponds to the certain space distribution of the light beams.

A diffusion board, according to the present invention, corresponds to a direct type backlight module having a certain space distribution of light beams emiited from the light sources. The diffusion board includes an incident surface configured for receiving the light beams. The diffusion board has fluorescent substance, and a distribution of the fluorescent substance corresponds to the certain space distribution of the light beams.

Comparing with the conventional direct type backlight module, the present diffusion board has fluorescent substance therein, and the fluorescent substance emits light beams excited by the light beams emitted from the light sources. Furthermore, because the distribution of the fluorescent substance corresponds to the certain space distribution of the light beams emitted from the light sources, the brightness non-uniformity problem, associated with the certain space distribution of the light beams emitted from the light source, is solved. The brightness uniformity of the direct type backlight module is improved. The present direct type backlight module does not include the light curtain; thus its configuration is simple, the assembly thereof is easy, and its light usage efficiency is high.

### BRIEF DESCRIPTION OF THE DRAWINGS

FIG. 1 is an isometric view of a direct type backlight module in accordance with a first embodiment of the present invention;

FIG. 2 is a cross-sectional view of a diffusion board made in accordance with the present invention shown in FIG. 1;

FIG. 3 is a cross-sectional view of a second embodiment of a diffusion board made in accordance with the present invention;

FIG. 4 is a cross-sectional view of a third embodiment of a diffusion board made in accordance with the present invention; and

FIG. 5 is an isometric view of a direct type backlight module in accordance with a fourth preferred embodiment of the present invention.

### DETAILED DESCRIPTION OF THE PRESENT INVENTION

Referring to FIG. 1, a direct type backlight module, in accordance with a first preferred embodiment of the present invention, is shown. The direct type backlight module includes a reflection frame 210, a plurality of light sources 220 arranged in the reflection frame 210, a diffusion board 230 and a brightness enhancement film 240. The diffusion board 230 defines an incident surface 231 and an opposite emitting surface 232. The plurality of light sources 220 are arranged adjacent to the incident surface 231 of the diffusion board 230. The enhancement sheet 240 is arranged adjacent to the emitting surface 232. The relfection frame 210 is further coated with a reflection layer 211 to reflect the light beams emitted from the light sources 220 for improving the brightness by increasing the using efficiency of light beams.

Referring to FIG. 2, the diffusion board 230 is configured for diffusing the light beams emitted from the light source 220 therein to make the light beams uniform. The diffusion board 230 includes a substrate 234 and a diffusion layer 235 formed directly on the substrate 234. The substrate 234 is made of a high transparent material, such as Polymethyl Methacrylate (PMMA), Polycarbonate (PC), etc. The substrate 234 is utilized to be a base of the diffusion layer 235. The diffusion layer 235 is made of a PC material with fluorescent substance. The diffusion layer 235 includes a plurality of first areas 237 corresponding in shape to the contour of the light sources 220 and a plurality of second areas 236 adjacent to the first areas 237.

The diffusion layer 235 of the diffusion board 230 is produced by injection molding. When manufacturing, different materials are injected into the first areas 237 corresponding in shape to the contour of the light sources 220 and the second areas 236. The first areas 237 are injected with ordinary light guide plastic material, while the second areas 236 is injected with light guide plastic material mixed with fluorescent substance. Those two material will be mixed in the mold cavity. As a result, the fluorescent substance distributes corresponding to the certain space distribution of the light beams emitted from the light sources 220. That is, a concentration of the fluorescent substance in the first areas 237 corresponding to the contour of the light sources 220 is lower than that in the second areas 236.

The diffuser layer 235 can be also a film material with a diffusant or a diffusion material. The method for forming the diffuser layer 235 can be directly coating, vapor deposition, vacuum coating or spraying. In manufacturing, the fluorescent substance is injected in the diffuser layer 235 and the fluorescent material distributes in a shape to the certain space distribution of the light beams.

In this embodiment, the fluorescent material may be fluorescein isothiocyanate (FITC) for emitting green light, nile blue A for emitting red light, rhodamine B for emitting yellow light, etc.

In use, the light beams emitted from the light sources 220 and reflected by the reflection layer 211, transmit to the diffusion board 230 and is evenly diffused by the diffusion board 230. Since the first areas 237 and the second areas 236 of the diffusion layer 235 of the diffusion board 230 have a different concentration of the fluorescent substance, and the fluorescent substance emits light beams with random directions excited by the light beams emitted from the light sources 220, the brightness distribution can be improved, the shadows is eliminated, and the uniformity is increased. The light beams are then exit from the emitting surface 232, and enter the enhancement sheet 240 to be enhanced.

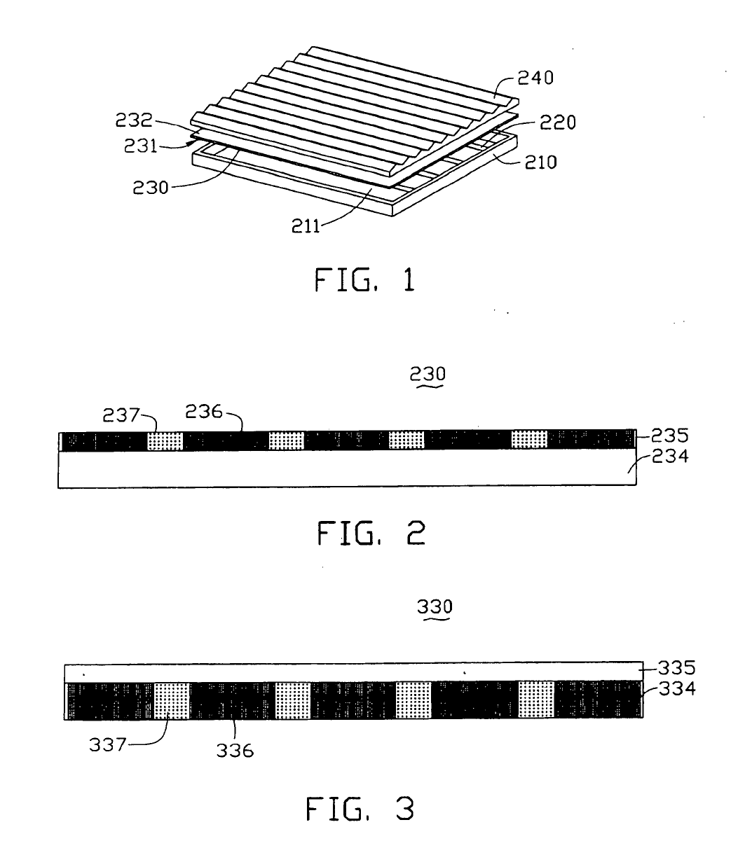

Referring to FIG. 3, a diffusion board 330, in accordance to a second embodiment of the present invention, is shown. The diffusion board 330 includes a substrate 334 and a diffusion layer 335. The diffusion layer 335 is a composite layer featuring on enhancement sheet. The substrate 334 is made of light guide material with fluorescent substance by injection molding. The fluorescent substance in the substrate 334 forms a certain space distribution. The substrate 334 includes a plurality of first areas 337 corresponding in shape to the contour of the light sources 220 and a plurality of second areas 336 adjacent to the first areas 337. A concentration of the fluorescent substance in the first areas 337 is lower than that of the second areas 336.

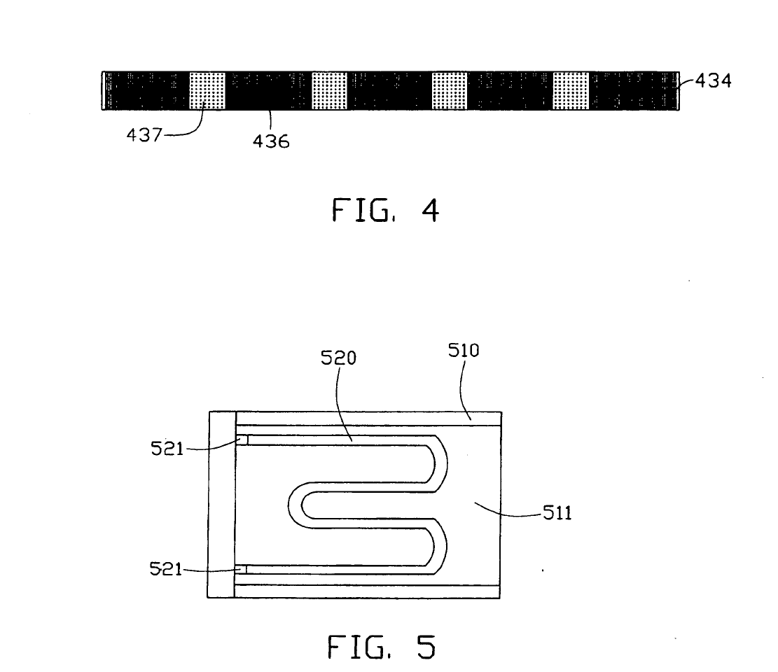

Referring to FIG. 4, a diffusion board 434, in accordance to a third preferred embodiment of the present invention, is shown. The diffusion board 434 is made of light guide plastic material with fluorescent substance by injection molding. The fluorescent substance in the diffusion board 434 forms a certain space distribution. The diffusion board 434 includes a plurality of first areas 437 corresponding in shape to the contour of the light sources 220 and a plurality of second areas 436 adjacent to the first areas 437. A concentration of the fluorescent substance in the first areas 437 is lower than that of the second areas 436.

Referring to FIG. 5, a direct type backlight module, in accordance to a fourth preferred embodiment of the present invention, is shown. The direct type backlight module includes a diffusion board (not shown), a reflection frame 510, and a light source 520 with a W-shaped configuration arranged within the reflection frame 510. The reflection frame 510 is further coated with a reflection layer 511 to reflect the light beams emitted from the light source 520. The W-shaped light source 520 includes a pair of electrodes 521 for powering the light source 520. The light beams emitted form the light source 520 has a certain space distribution, and high brightness areas form a W-shape. The diffusion board is a diffusion board above mentioned. Correspondingly, the low concentration areas form a W-shape.

The light source can be cold cathode fluorescent lamp or light emitting diodes, etc. An enhancement film instead of the enhancement sheet can be disposed on the emitting surface of the diffusion board.

While the present invention has been described with reference to particular embodiments, the description is illustrative of the invention and is not to be construed as limiting the invention. Therefore, various modifications can be made to the described embodiments by those skilled in the art without departing from the true spirit and scope of the invention as defmed by the appended claims.

1-6. (canceled)

7. A direct type backlight module, comprising:
at least one light source; and
a diffusion board having an incident surface and an emitting surface, the at least one light source arranged behind the incident surface, the diffusion board forming at least one first area corresponding in shape to the contour of the at least one light source and at least one second area, each type of area having a different concentration of a fluorescent substance mixed therein.

8. The direct type backlight module as claimed in claim 7, wherein the concentration of the fluorescent substance in the first area is lower than that in the second area.

9. The direct type backlight module as set forth in claim 7, further comprising a brightness enhancement sheet arranged on the emitting surface of the diffusion board.

10. The direct type backlight module as set forth in claim 7, wherein the diffusion board further comprises a substrate and a diffusion layer.

11. The direct type backlight module as set forth in claim 10, wherein the at least one first area and the at least one second area are formed in the substrate.

12. The direct type backlight module as set forth in claim 10, wherein the at least one first area and the at least one second area are formed in the diffusion layer.

13. The direct type backlight module as set forth in claim 7, wherein the diffusion board is a diffusion layer, and the at least one first area and the at least one second area are formed therein.

14. A diffusion board configured for use in a direct type backlight module, the direct type backlight module having at least one light source, the diffusion board having an incident surface and an opposite emitting surface, the diffusion board comprising:
at least one first area corresponding in shape to the contour of the at least one light source; and
at least one second area, each first area having a concentration of fluorescent substance mixed therein different than a concentration of fluorescent substance mixed in each second area.
